(19) United States
(12) Patent Application Publication
(10) Pub. No.: US 2002/0103828 A1
(43) Pub. Date: Aug. 1, 2002

(54) System and method for world wide web based mapping of multiple system name spaces

(75) Inventors: Ronald A. Kupiec, Chagrin Falls, OH (US); Paolo Argentieri, Richmond Heights, OH (US); Jeff J. Rochow, Chagrin Falls, OH (US)

Correspondence Address: Michael M. Rickin, Esq., ABB Automation Inc., Legal Department - 4U6, 29801 Euclid Avenue, Wickliffe, OH, 44092-1898, US

(73) Assignee: ABB Automation Inc.

(21) Appl. No.: 09/770,167

(22) Filed: Jan. 26, 2001

(51) Int. Cl. G06F 17/21; G06F 17/24

(52) U.S. Cl. 707/513; 707/530

(57) ABSTRACT

A web based name resolution service that associates one or more named entities in a first system with the corresponding names for those entities in one or more target systems. A XML document created in the first system is transmitted in a session and over a connection and protocol to a web server which activates an active server page. An object is launched that provides access to a database that contains the relationship between the name for the named entities and the corresponding name for the entities in the target system. A new XML document that contains the corresponding names is created and returned to the first system during the session and over the connection and the protocol that transmitted the XML document from the first system to the web server.

### 1. FIELD OF THE INVENTION

This invention relates to systems that maintain and retrieve the names, operations and parameters of entities in a name space of a system and associates these entities with entities in a target system name spaces.

### 2. DESCRIPTION OF THE PRIOR ART

Many business enterprises have multiple systems for maintaining information about an asset used in the business. For example the enterprise may have an accounting system, an inventory system, a maintenance system etc. each of which maintains information about an asset of the enterprise. Further each system may maintain its information about the asset under a name which is different than the name that another system in the enterprise uses for that asset.

In addition the enterprise may have many different clients, such as mobile, external and local clients, who need to obtain information about an asset from the other clients. For example, a local client may have information about an asset that is located at the site where the client is located which information should also be known by a system that is located at another location. The clients are connected to servers and at present the communications between clients and servers use a number of protocols and access methods depending on the type of network between the client and server. In addition, the data stream syntax and semantics are often platform dependent making interoperability difficult.

The difficulties arising from such a system can be illustrated by a simplified example of a valve that is part of a automation system used by an enterprise in the process or batch industries. The typical process or batch industry enterprise has many different departments such as engineering, operations, maintenance, documentation and accounting. Each of these departments has its own system for maintaining information about an asset and its own identifier for that asset. Thus the valve may be seen by the enterprise in many different contexts and by different names.

To the enterprise's process engineer the valve is known by a name in the process documentation which reflects the function of the valve. For example, if the enterprise is a process industry which make polymers as either an intermediate or final product and the valve is at the outlet of a polymer discharge tank, the valve may be identified in the process documentation as the polymer discharge valve. The valve is part of the control system at the enterprise and the operator in the control room typically refers to the valve by an alphanumeric designation which uniquely identifies the valve from other assets of the control system. The enterprise's maintenance department typically identifies an asset by its physical location to log service orders. Therefore, the maintenance department may identify the valve as V12-22-6.

The documentation department of the enterprise stores the service manuals for each asset. That department may identify the valve by the valve's manufactured part number. The enterprise's accounting department keeps track of the financial information for each capital asset. Typically each capital asset, such as the valve in this example, is identified by a unique identifier which includes the year of purchase. For the valve this identifier may for example be the asset number 97-23-579 where 97 is 1997 the year of purchase.

As can be appreciated each of these users have different needs for information. When these information sources need to interact the correlation of the resources must be done manually.

In addition to the problem of different data stores and applications the communication standards and software interfaces vary greatly between each of the data sources and corporate location. This makes data interchange difficult and seamless integration almost impossible.

### SUMMARY OF THE INVENTION

A method for associating one or more named entities in a first system with the corresponding names for the named entities in one or more target systems. The method has the steps of:

(a) creating in the first system a XML document containing a name for the one or more named entities;

(b) transmitting the XML document in a session and over a connection and a protocol to a web server;

(c) activating an active server page executing in the environment of the web server;

(d) launching an object providing access to a database containing at least a relationship between the name for the one or more named entities and the corresponding names for the one or more named entities in the one or more target systems; and

(e) creating a new XML document containing the corresponding names and returning the new document to the first system during the session and over the connection and the protocol that transmitted the XML document.

A method for associating one or more named entities in a first system with the corresponding names for the entities in one or more target systems. The method has the steps of:

(a) creating in the first system a XML document containing a name for the one or more named entities;

(b) activating an active server page executing in the environment of a web server to which the XML document is transmitted in a session and over a connection and a protocol;

(c) launching an object providing access to a database containing at least a relationship between the name for the one or more named entities and the corresponding names for the one or more named entities in the one or more target systems; and

(d) creating a new XML document containing the corresponding names and returning the new document to the first system during the session and over the connection and the protocol that transmitted the XML document.

Apparatus for associating one or more named entities in a first system with the corresponding names for the named entities in one or more target systems, the first system for creating a XML document containing a name for the one or more named entities. The apparatus has:

(a) a web server for receiving the XML document which is transmitted in a session and over a connection and a protocol to the web server; and

(b) the web server for:

(i) activating an active server page executing in the environment of the web server when the XML document is received by the web server;

(ii) launching an object providing access to a database containing at least a relationship between the name for the one or more named entities and the corresponding names for the one or more named entities in the one or more target systems; and

(iii) creating a new XML document containing the corresponding names and returning the new document to the first system during the session and over the connection and the protocol that transmitted the XML document.

A combination that has

(a) a first system having one or more named entities;

(b) one or more target systems having corresponding names for the one or more name entities;

the first system for creating a XML document containing a name for the one or more named entities,

(c) a web server for receiving the XML document which is transmitted in a session and over a connection and a protocol to the web server; and

(d) the web server for:

(i) activating an active server page executing in the environment of the web server when the XML document is received by the web server;

(ii) launching an object providing access to a database containing at least a relationship between the name for the one or more named entities and the corresponding names for the one or more named entities in the one or more target systems; and

(iii) creating a new XML document containing the corresponding names and returning the new document to the first system during the session and over the connection and the protocol that transmitted the XML document.

### DESCRIPTION OF THE DRAWING

FIG. 1 shows an overview diagram of the architecture of which the present invention is a part of.

FIG. 2 shows a typical physical layout wherein the present invention is used.

FIG. 3 shows the functional layout of the components of the web based mapper software of the present invention.

### DESCRIPTION OF THE PREFERRED EMBODIMENT(S)

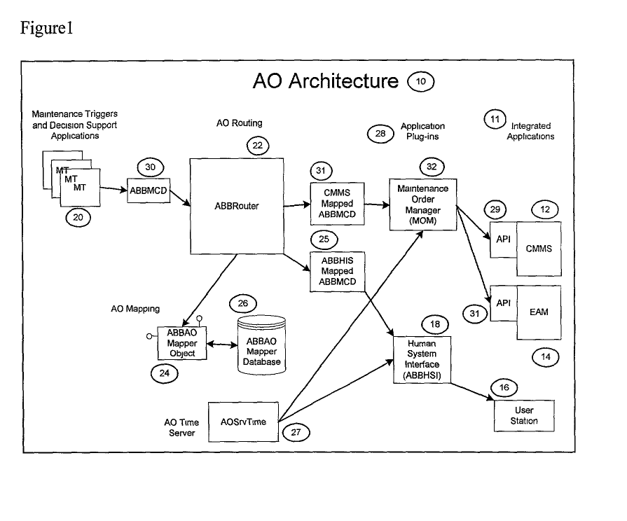

The web based mapping of the present invention is part of an architecture 10 known as Asset Optimization (AO) an overview of which is shown in FIG. 1. AO architecture 10 is designed to allow asset monitoring and decision support applications to interact with a variety of third party integrated applications 11 such as the computerized maintenance management system (CMMS) 12 and the enterprise asset management (EAM) 14 applications shown in FIG. 1. AO architecture 10 is also designed to allow asset monitoring and decision support applications to interact with plant monitoring systems represented in FIG. 1 by consoles 16 and human system interfaces (HSI) 18 with the goal of giving the user a complete, easy to use and configure, system that optimizes the use of plant equipment and processes.

AO architecture 10 comprises four primary types of software:

1. Sources of maintenance condition information represented in FIG. 1 by maintenance triggers (MT) 20 or information queries,

2. AORouting 22, AOsrvTime 27, AOMapping 24 and 26,

3. Application plug-ins 28 and generic application interfaces 29, 31 to third party applications 12, 14, respectively,

4. Integrated third-party applications such as CMMS 12 and EAM 14.

The MTs 20 produce maintenance condition documents 30 which represent messages used in asset optimization (AO). The maintenance condition documents 30 are transformed using the configuration in the AOMapper 24, 26 and routed by AORouting 22 to a specific application plug-in interface. The transformed maintenance condition documents are designated as 25 and 31 in FIG. 1. One example of such an interface known as the Maintenance Order Manager (MOM) 32 is shown in FIG. 1. The MOM 32 takes a transformed maintenance condition document 31 and uses this message-oriented information to manage the event (message) in relation to a specific integrated CMMS 12 application.

The AO architecture 10 also has the ability to route transformed maintenance condition documents 25 to HSI 18. This allows the system to alert operators and managers of current or pending abnormal conditions and maintenance needs. The HSIs 18 supported by architecture 10 can include user stations 16 such as control consoles, wireless networked computers, hand-held organizers, pagers, e-mail and telephone alerts.

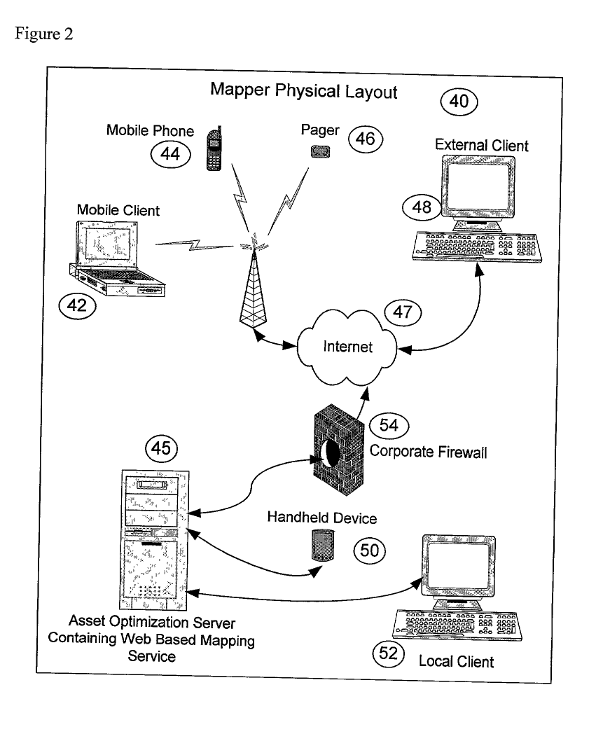

Referring now to FIG. 2, there is shown a typical physical layout 40 where the web based name resolution service of the present invention is used. Mapper service 24, 26 of FIG. 1 has many clients six examples of which are shown in FIG. 2. External clients such as mobile clients 42 use dial-up networking to access the server 45 that contains mapper service 24, 26 over the Internet. External clients such as mobile phone and pager clients 30 44, 46 access the server over commercially available services. External client 48 is located at a site which is remote from the site where the server 45 of the present invention is located and client 48 is directly connected to the service through the Internet 47. The physical layout 40 also has local clients in form of handheld devices 50 as well as traditional workstations 52.

All of the external clients 42, 44, 46, 48 are accessed to the server 45 through the local firewall 54 that allow messages in a protocol such as HTTP to access server 45. Each client 42, 44, 46, 48, 50 and 52 sends data relevant to an asset to the server 45 using a standard protocol such as HTTP in a standard format such as Extensible Markup Language (XML). The data from the client includes the name by which the client knows the asset.

As will be described in more detail below, the server 45 resolves the asset name used by the client in as many other namespaces as possible. The server 45 then returns the list of entities in the same format as the original request. This enables various other systems to easily exchange information about entities since each system only has to know about the local entity name. It is the server 45 that resolves the correct foreign names.

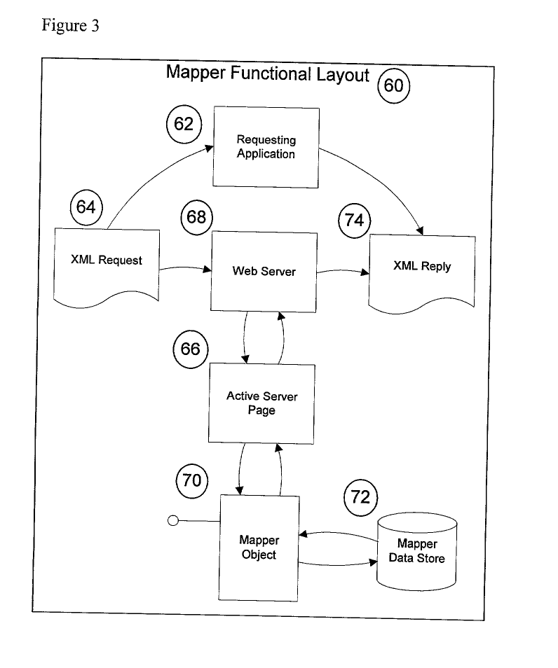

FIG. 3 shows the functional layout 60 of the components of the web based mapper software of the present invention and the data flow between these components. Some of the components shown in FIG. 3 are executed in server 45. The requests for relationships, that is, determining the alias names by which a given entity is known by other systems of the enterprise, in the software of the present invention are initiated by a software component 62 that needs the alias name(s) for a given entity. Component 62 can be a web page or a client application located on a remote system or a service component of the AO architecture 10.

The request is formatted as an XML document 64 and sent to the mapper interface active server page (ASP) 66 through the Web Server 68 which executes on server 45 using the Post command of the HTTP protocol. The ASP 66 then instantiates the mapper interface object 70 that interprets the requested XML document. The object 70 then queries the mapper data store 72 for all related alias names. As those of ordinary skill in the art can appreciate, object 70 can be embodied as a data dictionary allowing one to many and many to many relationships.

All of the related alias names are then formatted into a new XML document 74 that is returned by the ASP 66 through the Web Server 68 using the Response method of the HTTP protocol. The reply is then sent to the requesting application 62 over the same connection, session and protocol as the original request.

It is to be understood that the description of the preferred embodiment(s) is (are) intended to be only illustrative, rather than exhaustive, of the present invention. Those of ordinary skill will be able to make certain additions, deletions, and/or modifications to the embodiment(s) of the disclosed subject matter without departing from the spirit of the invention or its scope, as defined by the appended claims.

What is claimed is:

1. A method for associating one or more named entities in a first system with the corresponding names for said named entities in one or more target systems comprising the steps of:
(f) creating in said first system a XML document containing a name for said one or more named entities;
(g) transmitting said XML document in a session and over a connection and a protocol to a web server;
(h) activating an active server page executing in the environment of said web server;
(i) launching an object providing access to a database containing at least a relationship between said name for said one or more named entities and said corresponding names for said one or more named entities in said one or more target systems; and
(j) creating a new XML document containing said corresponding names and returning said new document to said first system during said session and over said connection and said protocol that transmitted said XML document.

2. A method for associating one or more named entities in a first system with the corresponding names for said entities in one or more target systems comprising the steps of:
(e) creating in said first system a XML document containing a name for said one or more named entities;
(f) activating an active server page executing in the environment of a web server to which said XML document is transmitted in a session and over a connection and a protocol;
(g) launching an object providing access to a database containing at least a relationship between said name for said one or more named entities and said corresponding names for said one or more named entities in said one or more target systems; and
(h) creating a new XML document containing said corresponding names and returning said new document to said first system during said session and over said connection and said protocol that transmitted said XML document.

3. Apparatus for associating one or more named entities in a first system with the corresponding names for said named entities in one or more target systems, said first system for creating a XML document containing a name for said one or more named entities, said apparatus comprising:
(c) a web server for receiving said XML document which is transmitted in a session and over a connection and a protocol to said web server; and
(d) said web server for:
(iv) activating an active server page executing in the environment of said web server when said XML document is received by said web server;
(v) launching an object providing access to a database containing at least a relationship between said name for said one or more named entities and said corresponding names for said one or more named entities in said one or more target systems; and
(vi) creating a new XML document containing said corresponding names and returning said new document to said first system during said session and over said connection and said protocol that transmitted said XML document.

4. In combination:
(e) a first system having one or more named entities;
(f) one or more target systems having corresponding names for said one or more name entities;
said first system for creating a XML document containing a name for said one or more named entities,
(g) a web server for receiving said XML document which is transmitted in a session and over a connection and a protocol to said web server; and
(h) said web server for:
(j) activating an active server page executing in the environment of said web server when said XML document is received by said web server;
(iv) launching an object providing access to a database containing at least a relationship between said name for said one or more named entities and said corresponding names for said one or more named entities in said one or more target systems; and
(v) creating a new XML document containing said corresponding names and returning said new document to said first system during said session and over said connection and said protocol that transmitted said XML document.
